(19) United States
(12) Patent Application Publication
(10) Pub. No.: US 2017/0243246 A1
(43) Pub. Date: Aug. 24, 2017

(54) CONTENT RENDERING SYSTEM DEPENDENT ON PREVIOUS AMBIENT AUDIO

(71) Applicant: Digimarc Corporation, Beaverton, OR (US)

(72) Inventors: Tony F. Rodriguez, Portland, OR (US); Mark J. Petrie, Portland, OR (US)

(21) Appl. No.: 15/590,763

(22) Filed: May 9, 2017

Related U.S. Application Data
(63) Continuation of application No. 14/098,971, filed on Dec. 6, 2013.
(60) Provisional application No. 61/734,763, filed on Dec. 7, 2012.
(60) Provisional application No. 61/738,632, filed on Dec. 18, 2012.
(60) Provisional application No. 61/903,559, filed on Nov. 13, 2013.

(51) Int. Cl. G06Q 30/02

(52) U.S. Cl. CPC G06Q 30/0251

(57) ABSTRACT

Users' browsing histories and other online activities are commonly tracked using cookies, and employed to customize users' web experiences. In accordance with certain aspects of the present technology, microphones, cameras, and other sensors of portable computing apparatuses are employed to gather information about users' offline experiences. This information can be used—alone, or in conjunction with traditional cookie data—to enable systems to adapt their behaviors based on a fuller view of user's circumstances. In one particular arrangement, rendered content depends on previous ambient audio. A great variety of other features and arrangements are also detailed.

### RELATED APPLICATION DATA

This application is a continuation of application Ser. No. 14/098,971, filed Dec. 6, 2013, which claims priority to U.S. provisional applications 61/734,763, filed Dec. 7, 2012, 61/738,632, filed Dec. 18, 2012, and 61/903,559, filed Nov. 13, 2013. The disclosures of these applications are incorporated herein by reference.

### BACKGROUND AND INTRODUCTION

Much of the online economy is driven by advertising; some reports estimate the amount spent on internet advertising in 2011 exceeded $80 billion.

In addition to end users, there are two classes of players in online advertising: companies that want their ads seen (e.g., Dell and Delta), and publishers that have online ad space available for sale (e.g., seattletimes<dot>com). The former companies are often termed the “demand side,” and the latter publishers are often termed the “supply side.”

Software tools are commonly used to automate both the supply and demand sides of online advertising.

“Demand Side Platforms” (DSPs) are software tools used by companies buying ad space (e.g., Dell and Delta). A company using a Demand Side Platform provides information about the target audience to which its ads should be directed, and a budget (e.g., daily or weekly) for the ad spend. The DSP software spends the budget to buy ad space on online sites where it determines the company's ads will yield the best return.

“Supply Side Platforms” (SSPs) are software tools used by online publishers who have ad space to fill (e.g., seattletimes<dot>com). The SSP software discerns information about a user who visits the web site (typically through use of cookie data), and determines which ad should fill an available ad slot in the web page delivered for that user's visit. (In placing third party ads, the SSP software typically conducts a quick online auction to identify the vendor willing to pay the most. SSP software is also used by retailers in placing ads promoting their own merchandise.)

When Joe Public requests a page be loaded from seattletimes<dot>com, a cookie on his computer is read and allows access to an associated dossier of information. This dossier—typically a file in a remote database maintained by an SSP vendor—contains history data about Joe's other online activities/experiences. It may also include other demographic data, from public and proprietary databases, etc. This information about Joe prompts a flurry of activity to fill an available slot on the seattletimes<dot>com web page with an ad from a brand that wants to tempt Joe.

The cookie is a gateway to stored context data about Joe, allowing the SSP to identify an advertiser to whom Joe represents a high-value customer. Naturally, the SSP wants to sell the ad slot for the best available price. The more candidate advertisers know about Joe, the more confident they can be in determining whether Joe is a close match to their target customer. The more advertisers know about Joe, the more confident they can be in paying top dollar to present Joe their ads.

A cookie assigns an identity to a user, and allows access to information about the user's activities. But these activities are always digital.

In accordance with certain aspects of the present technology, certain analog activities of the user are also memorialized, and help identify particular ads best suited for presentation to that user.

The foregoing and other features and advantages of the present technology will be more readily apparent from the following detailed description, which proceeds with reference to the accompanying drawings.

### BRIEF DESCRIPTION OF THE FIGURES

FIG. 1 is a flow chart of an illustrative embodiment, from the viewpoint of a user device.

FIG. 2 is a flow chart of an illustrative embodiment, from the viewpoint of a remote service.

FIG. 3 is a diagram of another illustrative embodiment.

FIG. 4 is a block diagram showing components of an illustrative system.

### DETAILED DESCRIPTION

The present technology has broad applicability, but necessarily is described by reference to a limited number of embodiments. The reader should understand that the technology can be employed in various other forms—many quite different than the arrangements detailed in the following discussion.

A first embodiment involves a smartphone or tablet “second screen” app. Such apps are often used in conjunction with television programs (and some radio broadcasts) to present auxiliary content that is complimentary to the primary television (radio) content. For example, such an app may present player stats to viewers of a football game, or present trivia quizzes to viewers watching a sitcom.

Shazam, Zeebox and IntoNow (Yahoo!) are exemplary second screen apps. Other second screen apps are more specialized, sometimes being tailored to a particular television show (e.g., Grey's Anatomy or NCIS), or to a specific broadcaster.

Second screen apps typically identify the primary content to which the user is being exposed through use of audio watermarking or fingerprinting technology. These techniques process sampled content to derive corresponding identification information. Alternatively, program identification information can be broadcast (e.g., by Apple's Bonjour service) on a local wireless network to the second screen app from the television system, or from another device involved in delivering the primary content to the user.

Regardless of how the primary content is identified, second screen apps complement such content by identifying one or more corresponding items of secondary content from which the user can choose. These secondary content items are typically identified by querying a database using the program identification information. Sometimes, the secondary content items are identified (or conveyed) with the primary content stream.

Consider a radio station, KXYZ-FM, that distributes a tablet app with second screen features (somewhat a misnomer in the case of radio, since there is no primary “screen”). When the app is launched, it downloads the latest version of an audio fingerprint or watermark detector (e.g., JavaScript) from the KXYZ-FM web site. This detector listens to ambient audio, and seeks to identify it (e.g., by computing fingerprint data, and forwarding to a database for matching against a collection of fingerprints for reference content). For example, ambient audio in the user's environment may be identified as a Bob Dylan song (e.g., “Po' Boy”). A database of secondary content is next consulted and may indicate, e.g., that the app should respond by presenting an on-screen quiz testing the user's knowledge of Bob Dylan trivia.

(Sometimes the app may successfully identify the primary content being rendered in the user's environment (e.g., a song by The Eagles, or audio from local television channel 6), but find that the secondary content database does not identify any secondary content that corresponds.)

When the tablet app transmits detected watermark or fingerprint data (or other identification information) to a remote server for response (if any), it also transmits an identifier of the tablet—or its user. Commonly, but not necessarily, this identifier takes the form of a cookie. If KXYZ-FM uses a Supply Side Platform from SuperCo, the tablet's data exchange can be arranged so that a ‘superco’ cookie is transmitted from the tablet to the SuperCo server. (An exemplary cookie comprises a small file containing random data, e.g., A86FC2, with a descriptive name, e.g., superco.txt. The random data allows cookies from different users to be distinguished.)

Also transmitted to the SuperCo server, for association with the user's cookie, is information identifying the ambient audio. For example, this information can comprise a song title or other metadata identified by looking-up a decoded watermark identifier in a metadata database (Bob Dylan's “Like a Rolling Stone;” The Eagles' “Hotel California”), or it can be title or other metadata information for a television program, identified by matching derived fingerprint data against reference data in a fingerprint database (e.g., the Oct. 7, 2012, 60 Minutes broadcast). Alternatively, the identification information can comprise a TV program title as broadcast by the television system, etc. (It may also comprise the derived audio fingerprint data, or extracted watermark ID, although this is less common.)

This identifying information is sent to SuperCo by the tablet (e.g., the tablet app), or by KXYZ-FM, or by a third party involved in associating identification information with metadata.

In some instances, not only is the identified content associated with the cookie; so is the delivery channel by which the content was delivered to the user. For example, fingerprinting may be employed to identify the title of the content (e.g., Seinfeld, episode 125), and watermark decoding can reveal its distribution channel (e.g., broadcast by KABC-TV, on Oct. 5, 2012, at 10:00 pm). Similarly, a broadcast from a television system may indicate that the television is tuned to Cox Cable channel 47.

Still further, information that identifies the content recognition software or second screen app on the user's tablet (e.g., the KXYZ-FM second screen app), can also be sent and stored in association with the cookie.

All of this information is context data—useful, e.g., in identifying advertising that is relevant to the user.

For example, consider what happens if the user of the KXYZ tablet app later visits the music page of the amazon<dot>com web site. Amazon wants to place a relevant ad on the web page delivered to this user. If Amazon uses the SuperCo SSP software, the user's tablet will send the superco cookie to the SuperCo server as part of loading the Amazon web page. By reference to stored data associated with the cookie, SuperCo will see the user's audio environment has included music by Bob Dylan and the Eagles. Knowing this context about the user, SuperCo can select—from the Amazon inventory of available ads—an advertisement promoting a newly-released boxed set of Bob Dylan music CDs.

If the user clicks the Dylan ad, credit may be due to KXYZ-FM as one of the infrastructure players whose involvement led to the user's click. A small payment may be due to KXYZ-FM (or a larger payment, if the user actually completes a purchase of the Dylan boxed set). Additionally or alternatively, if a watermark or other information identifies the distribution channel through which the sensed Dylan audio was provided to the user's environment, that entity may also deserve a tribute payment.

In the example just-given, the selection of an ad for a Dylan boxed set was based on the user's content consumption history. But the same principles can adapt the presented advertisement (or other content) to the content detected in real-time in the user's environment. For example, if the ad for the Dylan boxed set is initially detected and then, while the user is still on that Amazon web page, his device detects audio from the television show Mad Men, the system can swap-out the Dylan ad and replace it with an advertisement for Mad Men-related merchandise available on Amazon.

Such updating of ads in real time is facilitated by web 3.0 standards, which enable on-going communication between a browser and a web page server. Knowledge about the user's instantaneous environment allows still better tailoring of promotional content—better suiting the user, the advertiser, and the supply side provider.

Moreover, the context information that can be fed-back to the web page server (or other destinations) is not limited to information about media content in the user's environment. Information about mouse movement or other user interaction, for example, can also be relayed from the user's device, and serves to signal that the user is active on the web page—and is not off in the kitchen, etc. Again, more accurate characterization of the user and his context leads advertisers to bid higher for available ad slots.

It will be recognized that cookies historically have been used to make assertions about users' digital activities, e.g., User A visited web sites X, Y and Z; User A clicked on a news article about Lance Armstrong and on an online catalog item offering a Shimano derailleur. The present technology extends this capability to aspects of the user's physical world, e.g.: User B listened to Bob Dylan music (even if on an analog radio), and watched a documentary film about industrialized farms (even if in an analog cinema).

Presently, content is typically identified “on-demand” (e.g., by pressing a ListenNow button on a second screen app). In the future, however, tablets and other devices may routinely perform content identification as a background operation, e.g., as an operating system service rather than as part of a second screen application. With the user's permission, these content identifiers can all be stored in association with a user identifier (e.g., cookie), providing a rich source of context by which the user's needs may be better met.

While cookies are presently used primarily for ad serving, their basic concepts and usage models can be employed more extensively. Consider a user who consumes Spanish language media, primarily. This fact can be discerned by examination of the content IDs that are stored in association with her cookie identifier (e.g., identifying newscasts from the Univision network, telenovelas, etc.). When this user visits the web site of Acme Appliances for the first time, the cookie data can be sent and serve as a type of profile information. For example, the Acme web site can determine, from a listing of media content consumed by the user, that Spanish is a favored language. Accordingly, a Spanish language version of the Acme web page can be delivered to the user instead of a default English language version.

(Language can also be determined by an audio classifier, which takes audio-related information as input, and outputs a signal indicating the language of the input audio.)

Age can be similarly inferred from content consumption habits. (Audiences for movies directed by Tim Burton tend to be under 30 years old; audiences for movies directed by Federico Felini tend to be over 40 years old; etc.) Educational background may also be correlated to media consumption (relatively few high school dropouts favor films by Akira Kurosawa). Again, web or other content delivered to the user may be tailored in accordance with demographic classifications, for which the user's history of media consumption can serve as a proxy.

It should be recognized that traditional cookies are not needed to practice the present technology. In some instances, use of traditional cookies is actually an impediment, since browsers and other applications typically place strict limitations on their use (e.g., a Superco cookie can be sent only to Superco—not to Acme Appliances, etc.) But other identifiers can serve in a similar capacity.

An implementation that does not use traditional cookies involves the Apple iCloud service. iCloud enables sharing about history of browsing states between a user's devices. A user who leaves a web page on a desktop computer to commute home, can open the same web page on a tablet (using the iCloud infrastructure) and continue browsing on the ride home, from the point she left off. Similarly, a history of the user's analog content consumption, as determined by one device, can be stored in the user's cloud account and employed to tailor other content delivered to the user on the same or other devices. Here, no cookie is used. Instead, the user is identified by the cloud account into which she is logged-in, and in which content consumption history is logged.

Cookies, or other identifiers, can form part of metadata statements made by the user's device. Consider a user's tablet, which is listening continuously to the user's environment and identifying the content it hears. Each time a new item of content is identified, and/or each short interval of time (e.g., every 2 minutes, 5 minutes, or 10 minutes), the device spews a cookie, associated with a content identifier (e.g., an ISAN identifier: International Standard Audiovisual Number). The device memory may have a stored cookie with the file name SSP123.txt, which stores the value A86FC2, issued by Supply Side Provider Superco. Each time content is identified, the device writes a metadata statement that includes the file name or value of the cookie, combined with the content's ISAN Identifier—forming a historical record of the user's environmental state. This information may be stored locally on the device, and/or transmitted for storage a cloud account associated with the user (e.g., iCloud), and/or transmitted for storage in a database maintained by Superco, etc. The metadata statement may take the form of a linked data RDF (Resource Description Framework) triple. (See, e.g., patent publication 20120154633, and references cited therein, for more about linked data.)

Just as content identified from the user's environment can serve as context, so, too, can other sensor data from a device, e.g., accelerometer, gyroscope, temperature, barometric pressure, GPS/location, etc. All such information is useful in serving up relevant ads, and otherwise tailoring experiences delivered to users.

In some instances, audio context can serve as a proxy for location information. Consider a user shopping in Wal-Mart, with a Wal-Mart app running on his smartphone. To use the app, the user has logged-in with his Sam's Club member ID and password.

While shopping, the user pauses in front of a display of Rubbermaid products—inspecting storage bins. The app includes an audio WM detector, and the store plays differently-watermarked background music in different zones of the store. The app's watermark detector decodes a watermark indicating that the user is in the Housewares-Bin Storage section of the store. The app—or a remote server with which it communicates—notes this fact, and sends it for storage in a SSP database, associated with a supply side cookie from the user's smartphone. The fact that the user remained in that part of the store for ten minutes is also recorded in association with the cookie.

When the user later goes to check-out, he presents his Sam's Club membership card. The user's items being purchased are tallied for checkout, and corresponding item identifiers are also stored in a database association with the user's Sam's Club ID. Curiously, the user did not buy any Rubbermaid storage bin—despite pausing in that section for ten minutes.

Based on the user's apparent interest in such a product, and his failure to purchase, Wal-Mart expresses its interest to present a Rubbermaid advertisement to that user, the next time an available ad slot comes up on a web site the user browses. Sure enough, at home that evening, the user fires up a tablet computer and navigates to a sports news site. That web site receives the user's cookie as part of the initial data exchange, and advertises availability of an ad slot on that user's tablet to the highest bidder. With its knowledge of the user's physical presence at the Rubbermaid display in its store earlier that day, Wal-Mart makes an offer to buy the ad slot at a price that no other advertiser could justify to pay. It wins the auction and presents to the user a display ad for Rubbermaid storage units—touting free shipping on orders over $25. The user was earlier chided by his wife for not having brought one home from the store, so clicks the ad and completes a purchase. Everyone is happy.

Wal-Mart is glad to conclude that sale, but is concerned that the user—and two dozen other shoppers this week—lingered at the Rubbermaid display, but did not purchase such a product while they were in the store. That's an opportunity for improvement. Alerted by this information from the system, the Wal-Mart store manager goes out on the floor to assess the display, and decides it might do better re-positioned to be closer to office supplies, rather than amidst picture frames and pillows. The next week the manager's move is vindicated—sales of Rubbermaid storage units are up, and fewer shoppers lingered without purchasing.

Applicant's previous work, detailed in patent publications 20110212717 and 20110161076, described how information about a user's auditory or visual environment can be published to an auction marketplace, where bidders compete for the opportunity to provide related services. The present technology is well suited for use in such applications. In particular, a system can publish the user's sensed context information, with cookie information. The context information can be sampled audio, identifying information (e.g., fingerprint or watermark data) derived from the sampled data, and/or metadata (such as song title or movie title) identified by reference to the identifying information. The context information can additionally include other context variables, such as location information, motion data, etc. The cookie information can serve as an anonymous identifier of the user, by which other profile information about the user can be obtained.

### Additional Disclosure

While the present disclosure has focused on cookie-like use of physical context information sensed by a microphone, it will be understood that there are many different types of physical sensors, and all may be used with the present technology. For example, the technology can be practiced with camera data, magnetometer data, RFID/Near Field Chip sensors, etc.

Camera data can be used to identify physical objects near the user, or with which the user interacts. (This will become increasingly prevalent as head-worn computing apparatus proliferates.) Similarly with NFC data, sensed from NFC (RFID) chips in the user's environment. Olfactory sensors can provide further information about the user's environment. Cookies are suitable to represent all such information.

In accordance with another aspect of the technology, when a user visits a web site (e.g., using a tablet computer), the web site may launch a Java app (or call a Java Native Interface) that talks to one or more of the tablet's sensors (with user approval) and collects sensor data. This information is stored in association with a cookie (which is written, if not pre-existing). Additionally, or alternatively, this sensor information—polled at the request of a remote computer associated with the web site, may be hashed to yield a Globally Unique Identifier (GUID). The GUID may, for example, be a function of events/information that one or more of the above-noted sensors has observed in the prior interval of time, e.g., 5 or less, 10, 30, 60, or 300 or more, seconds or minutes. This GUID can be written to a cookie (i.e., stored in a database in association with an identifier). This can be useful when it is desirable to place the user and/or device in a particular physical context, without revealing details.

If devices of two users, both in the same physical environment (i.e., having shared sensor context) at the same time, create such GUIDs, they should match, or be within an error tolerance apart (e.g., within a specified Euclidean distance or percentage of each other). If the fact of such co-presence is thereby established, a computer device might allow the two users to interact in a manner that might normally be restricted. For example, music or other entertainment content available to one user might be made available to the other user. If the two users visit the same web site/service, it may invite the users to share information, chat, listen to the same audio stream, etc., based on the common physical/sensor history (which may have been at a previous time).

In such an arrangement, a user's context information (or a hash of such information), stored at different times at a cloud repository, in association with a unique, anonymous identifier of the user (or the user's system, e.g., a cookie), enables a variety of powerful capabilities.

For example, third parties (e.g., supply side providers/platforms, in currently-popular systems) employ cookies to leverage historical context about the user. The cookie contains such historical information, or provides a key into a contextual database in which a record of the previous contextual history of the user/device is stored.

Consider Steve's smartphone or wearable computer system, which periodically reports context information to a cloud database. (Headworn computer devices are discussed, e.g., in applicant's patent application Ser. No. 13/651,182, filed Oct. 12, 2012 (now U.S. No. 8,868,039).) When visiting a web site, Steve's device senses information about his physical context—what the microphone is hearing, what the camera is seeing, the barometric pressure, Steve's GPS coordinates, etc. Related information is written to a cloud repository, with a cookie identifier. For example, on hearing a particular sound S, the device sends hash/fingerprint data FS. The information stored in the cloud may not identify Steve by name, but it indicates that a person/device associated with a particular cookie identifier experienced sound that yields a fingerprint FS, at a particular date and time (and, if authorized, location).

As Steve browses the web with his smartphone, additional information is sensed (perhaps triggered by queries from the web server or another remote computer, which Steve's device is authorized to answer). This information, or derivative information, is sent to the cloud for storage—as part of a cookie cache, or associated with a cookie identifier. The cookie may identify Steve to a particular web site, or to a particular service (e.g., Google, or another ad network). Sensed sound information yields derivative data SOUND-DF34A967EA; a recognized Bob Dylan song yields derivative data SONG-8FF7A9D66C; a decoded digital watermark from The Daily Show playing in the background yields derivative data DWMAUDIO-0BEF838E26; a voice recognized to be Steve's friend Bob yields derivative data SPEAKER-2D2A54A4DF; recognized speech by Bob yields derivative data SPEECH-1A7BC15AA6; Steve's location at 45°18′18″N 122°58′2″W yields derivative data GPS-9389DEB5C3; the current barometric pressure yields derivative data BARO-EFOBOE93F5; a can of Coke glimpsed by the smartphone camera yields derivative data PRODUCT-CFB9800146; a garlic aroma from food simmering in the kitchen and sensed by the phone's olfactory sensor yields derivative data SMELL-AD33A3E8CC; Steve's heart-rate, sensed by a biometric sensor, yields derivative data HEART-3F88B65334; etc., etc.

Thousands of contextual assertions are thus made in connection with Steve's cookie identifier. If Steve's cookie identifier is A9C1B87, then a cloud database may contain entries including:

A9C1B87:SOUND-DF34A967EA

A9C1B87:SONG-8FF7A9D66C

A9C1B87:DWMAUDIO-OBEF838E26

A9C1B87: SPEAKER-2D2A54A4DF

A9C1B87:SPEECH-1A7BC15AA6

A9C1B87:GPS-9389DEB5C3

A9C1B87:BARO-EFOB0E93F5

A9C1B87:PRODUCT-CFB9800146

A9C1B87:SMELL-AD33A3E8CC

A9C1B87:HEART-3F88B65334

Each such entry is typically time- and date-stamped (and less frequently location-stamped), but such notation is omitted above, for clarity.

The database naturally includes similar records for other individuals and/or devices (i.e., other cookie identifiers). Thus, similar contextual assertions are stored for Tom (cookie B56789C), Dick (cookie C581505) and Harry (ED7FE8B). The aggregate collection of such entries can be inverted, and sorted by the contextual statement (rather than by cookie). Such operation may reveal that Tom and Dick—like Steve—listen to Bob Dylan music. Such operation may further reveal that Bob's voice has also been recognized in audio sensed by Harry; and that Steve and Dick sometimes spend noon hours on weekdays together. (Again, nearest-neighbor constructs can be employed to deal with derivative data that is slightly different, but corresponds to the same or similar information—like GPS information.) Social network linkages can be gleaned from such information (e.g., the apparent social relationship between Steve and Dick, and Steve's and Harry's evident exposure to Bob).

In another arrangement, Steve is surfing the web, as before. However, instead of the cookie/context information being sampled and uploaded during a visit to a particular web site or service, it is routinely and periodically logged (e.g., every five minutes, or other interval as noted above) by the operating system of Steve's device, e.g., Android, during the period that Steve is using the device. Steve may be using a tablet that is provided to him free of monthly charges, by Google's subsidiary DoubleClick. In exchange, whenever Steve visits a web site for which DoubleClick is an advertising supplier, Steve's operating system uploads to DoubleClick the stored, historical DoubleClick cookie information gathered by the operating system since the last such upload. Alternatively, code in the operating system (or a resident application program) can upload logged cookie information to DoubleClick in response to other another trigger, such as the first browsing session of each day.

All such arrangements serve to create a historical record of context, so that subsequent supply side advertising events can be better matched to Steve's circumstances.

Reviewing the prior art, consider what happens when Steve's browser navigates to an article in the sports section of the online New York Times, concerning new safety standards for wooden baseball bats. The New York Times web server replies with HTML code that tells Steve's browser where to get content for that page, and how to format it. As is familiar, part of this returned code includes an ad tag URL that, e.g., directs Steve's browser to a DoubleClick ad server. The ad tag takes the form of an http string that—in addition to including the host address for the DoubleClick ad server (http://ad<dot>doubleclick<dot>net/), also includes other information, including a code identifying the New York Times web site, a topic or zone code indicating that Steve is within the sports section of the paper, and a sub-topic/sub-zone code indicating the requested article relates to baseball. This hierarchy allows more precise targeting of advertising, and optimization of ad revenue. (E.g., the New York Mets baseball team may pay a penny to present an ad (offering upcoming game tickets) to a reader of the New York times, but may pay 2 pennies with knowledge that the reader is in the sports section, and may pay a dime with knowledge that the reader is interested in baseball.)

In accordance with the certain embodiments of the present technology, the URL may be created—or modified—dynamically, as a function of context. For example, a software component on Steve's device (e.g., resident in the operating system, or part of a browser plug-in, or Java code running with a web page) can collect sensor information about Steve's physical context, or can read context data gathered earlier and stored locally. It can then dynamically form an ad tag URL, e.g., by appending such context information to the ad tag provided from the web site. That is, whereas prior art ad tags were static, a tag can instead start with a static part (e.g., from the web site), and build from it a dynamic ad tag URL employing physical context information.

(Such an arrangement can alternatively, or additionally, recall cookie information for the web site earlier stored on Steve's device, or recall an ad tag cached on the device from an earlier visit to that web site, and author an ad tag URL with such information as a starting point.)

Consider, next, a point of sale (POS) system in a bricks-and-mortar grocery store, which identifies purchases with users—without use of a store “loyalty” card. Each POS terminal has one or more sensors, such as a barcode scanner, a camera, a microphone, a scale, etc. Shopper Steve carries a smartphone or other such device with its own set of sensors, and code (e.g., in the operating system or an application) that publishes contextual information in an anonymous fashion.

As Steve is checking-out at one of the store's several POS terminals (e.g., in checkout Lane 4), purchased items are scanned by the POS barcode scanner. Object1 is a six-pack of Sprite soft drink. Object2 is a jar of Old El Paso salsa. Object3 is a can of Science Diet cat food. Etc. The barcode scanner is linked to the POS system, and reports a GTIN (Global Trade Item Identifier) number as each object is scanned (e.g., 549410582762, 923364619460, 837280103520, etc.)

The POS system relays each of these GTIN identifiers, as it is received from the scanner, to a cloud-based database, together with information identifying the store and checkout terminal (lane) from which the data originated. The database time- and date-stamps this information, and stores it.

The barcode scanner, or the POS terminal, also emits feedback signals that are sensed by Steve's smartphone. In one particular arrangement, each time the barcode scanner reads a GTIN code, it emits an audio signal that encodes the GTIN identifier. For example, a chord of 13 different tones can be sounded for 200 milliseconds—with each tone drawn from a different library of ten tones, identifying a 0-9 digit at a different position in the GTIN string. Or an audio signal can be frequency-shift-keyed to convey 13 ASCII character codes corresponding to the 13 GTIN digits, at a data rate of 300 bits per second, including error correction overhead. (Of course, other forms of feedback signals can be employed, such as Bluetooth and other wireless data, and ultrasonic audio.)

Steve's smartphone senses this feedback signal (with a microphone, in the foregoing arrangement), and decodes the GTIN identifiers. These decoded identifiers comprise a sequence that is temporally aligned with the time-stamped sequence of GTIN identifiers received by the cloud database from the store's POS system. The smartphone stores these decoded identifiers, and also sends the sequence of decoded identifiers to the cloud database (with an anonymous identifier assigned to Steve, or hashed from information specific to Steve; such an identifier may be the letters DFGHJ). The database matches the smartphone-sent GTIN sequence with a GTIN sequence from the POS terminal in Lane 4 of that grocery store. Anonymous Steve is thus associated with the purchase of the soda, salsa, and cat food, in Lane 4, through the smartphone's publication of sensed audio context information to the cloud repository.

The set of identifiers thus serves like a fingerprint, by which Steve's checkout transaction can be identified, and distinguished from other shoppers' checkout transactions.

The next time Steve enters the store, this historical record of purchases can be recalled based on the anonymous identifier DFGHJ, and used to provide coupons, targeting advertising, etc. (Steve's smartphone may have app software, distributed by the grocery store, in which the DFGHJ identifier is stored, and which serves to present coupons and other information.) This provides loyalty card-like functionality, without any use of a loyalty card. Nor does it make any use of Steve's credit card or debit card number (a technique on which some other shopper-identification systems are based).

(Loyalty rewards may similarly be provided to Steve outside the grocery store, e.g., a discount on fuel purchased at a gas station, based on a prior month's tally of purchases made at the grocery store.)

Moreover, this information has utility outside the grocery store. The DFGHJ identifier can be used like a cookie—to permit access to this record of physical shopping history elsewhere. For example, Steve may later view a Monday night football game, while surfing the web on the smartphone. The smartphone microphone senses the game audio, which enables identification of the football broadcast by audio fingerprinting or digital watermark decoding. A corresponding contextual assertion about Steve's activity is written to cloud storage. When Steve surfs to the front page of the New York Times, the phone authors an ad tag URL that conveys information about his activity (watching football), and also conveys Steve's DFGHJ identifier. The GTIN codes that are cloud-associated with this identifier reveal Steve's brand preferences. (Part of each GTIN code is a plural-digit “Global Company Prefix” field, identifying the company that provided the product.) When the ad server is queried for an ad, it can take into account Steve's football-watching activity, and Steve's historical preference for Coca Cola products over Pepsi products (as evidenced by all the Coke-prefixed GTIN codes associated with the DFGHJ identifier). It can then, e.g., select a football-themed Coke ad for presentation on the New York Times front page that Steve's device is presently loading.

In the barcode scanning example given above, the POS terminal provides feedback data memorializing the GTIN codes for the objects Steve is buying. The same functionality can be achieved without such feedback GTIN code data. For example, each time the barcode scanner in Lane 4 decodes a barcode, it can emit a two-tone, 200 millisecond beep, e.g., 1200 & 1300 Hz. (Other lanes can do likewise, with different tone pairings.) As before, each time the POS terminal reads an object's GTIN code, it sends the code to the database, which makes a time-stamped record. Meanwhile, Steve's smartphone senses these beeps, and reports each such detection to the database, with his DFGHJ identifier. Again, the database time-stamps and stores such information.

In this case, a temporal fingerprint is defined by the intervals between GTIN reports from the POS terminal (e.g., 1.3 seconds, 0.9 second, 0.9 seconds, 1.1 seconds . . . ). This temporal fingerprint is matched with a corresponding temporal fingerprint defined by the smartphone's report of beep detections. Again, Steve's shopping history is discerned, and stored in association with his anonymous identifier.

Steve's smartphone may detect and report the scanner beeps while still in Steve's pocket. After a match is established with the temporal sequence of GTIN codes reported by the POS terminal (e.g., after six or eight items have been scanned), the cloud database can look up any electronic coupons stored in a cloud wallet associated with the DFGHJ identifier, and can inform the POS terminal of their particulars (e.g., 50 cents off a six-pack of Sprite). The POS terminal can make the adjustment in the checkout tally—without Steve having identified himself in the store, and with the phone still in his pocket. (Or, if the coupon data are stored in the smartphone instead of in the cloud, once the temporal sequences are matched, the database can query the smartphone for its coupons. The smartphone can send its collection of coupon data, and the cloud can relay any that apply to the POS terminal. Once they have been redeemed, such information can be reported by the POS terminal to the cloud, which in turn confirms such redemption to the smartphone wallet.)

In other arrangements, the matching of temporal sequences can be performed by the smartphone, rather than the cloud database. For example, the store can broadcast—on its WiFi network—GTIN codes decoded by each POS terminal barcode scanner in the store, with each GTIN code being time-stamped and paired with an identifier of the POS terminal. The smartphone can derive temporal fingerprints for each POS terminal from such information, and match one such fingerprint to the temporal sequence of beeps it detects during checkout. When a matching sequence is identified, the smartphone transmits its coupon data to the store POS system (over the WiFi network, or otherwise), noting the POS terminal tally to which the coupon credit should be applied.

In alternative arrangements, the list of GTIN codes reported by the POS terminal in Lane 4 can be associated with Steve, simply by Steve's smartphone reporting its GPS location to the database, with his DFGHJ identifier. Alternatively, Steve's phone can gather information indicating his location in Lane 4 by a short range wireless beacon that marks that lane, or by the distinctive frequency of confirmation beeps issued by the barcode scanner in that lane, or by an RFID chip positioned in that lane, as sensed/reported by Steve's phone.

(It should be recognized that the arrangements described above provides multi-factor authentication of the user—reducing fraud potential. That is, the smartphone serves as a physical token—an ownership factor, and the beeps or other context that the phone senses serves as a knowledge factor.)

Steve may return nearly every day to the same grocery store—each time paying with cash. The store notes his frequent visits, and works to lock-in his continued patronage by offering a branded credit card that provides a 2% cash rebate on purchases made at that grocery chain. The offer is made the next time Steve checks out with a clerk-attended POS terminal, with the clerk verbally extending the offer, and pointing out that details—including a calculation of how much his cash rebate would be based on an interval of past purchases—are printed on his register receipt.

Related technology can be used with roving store clerks, e.g., at a Home Depot hardware store. Steve wants help concerning a particular item he is thinking about buying (if I buy this Moen shower head, will I require a metric wrench set to install it?), and taps a “Help” button on the Home Depot app on his smartphone. The app directs him to take a picture of the item, from which it then may extract identification information. The app also directs a sensor in the phone to capture information that serves to identify Steve's location. (This can be done, e.g., by decoding a digital watermark in music playing in that part of the aisle, or by an ultrasonic or wireless radio beacon in that part of the aisle, or by LED lighting modulated to convey location information, or other indoor location technology.) All such information is written to a remote database, together with an anonymous ID assigned to Steve by the app. Locations of the store's clerks are similarly determined, and a nearby clerk is alerted.

Information about the customer's situation is sent to the clerk's smartphone (e.g., the shopper's location, and a picture of the product, or the name of the product as discerned from a barcode on the package or by object recognition). The smartphone is also sent any other data gleaned from this customer today (such as other Help requests from that anonymous ID, information about other images captured using the store app for price-lookup, information about web sites recently visited by a device having the same IP address on the store's WiFi network as the IP address from which the Help request was received, etc.). The clerk may thereby learn that the customer recently reviewed an Amazon web page about a Kohler shower head, and used a barcode scanning feature in the Home Depot app to learn the price of a waterproof indoor can light fixture.

The clerk walks to Steve's aisle location, and looks for a person puzzling over shower heads. The background information about the customer's interest in shower hardware suggests to the clerk that the customer is involved in bathroom remodeling—helping the clerk better serve the customer.

All such context information about Steve and his interests is stored with a cookie identifier by the Home Depot app, e.g., DoubleClick's cookie XYZ243. Information from the store's POS system is also written to such a cloud database, and memorializes that Steve left the store purchasing only a drill bit.

A week later, Steve is at the airport—still thinking about his remodeling project, and surfs to a home improvement web site while waiting for his flight. Through the DoubleClick cookie, it is found that this user was recently in Home Depot and asked a store clerk about a Moen shower head, but did not purchase it. As a consequence, DoubleClick selects a Moen shower head advertisement to display on the home improvement web site.

(The reader is presumed to be familiar with personalized retargeting of online advertising, using cookies. The foregoing arrangement extends such methods from the online world to the physical realm.)

Reference was earlier made to a POS system that acquires visual information from a retail product (e.g., by a barcode scanner), and relays data derived from such information (e.g., a GTIN identifier) in audio form to a smartphone. This may be regarded as a form of synesthesia—a phenomenon detailed in a Wikipedia article by that name.

There are many instances where such arrangements are useful. One is in a car, driving. The car senses its location, processing information from a GPS radio receiver. The car emits audio or ultrasonic tones representing this location data, and the smartphone senses it. Reciprocally, information gathered by one type of smartphone sensor can be relayed to a car, and received using a sensor of a different type in the car.

Always-On/Wearable

Multiple wearable devices are now available in the market, with Sony, Samsung, Pebble and others first to market at scale using a watch form factor. These devices contain multiple sensors and are capable of creating actionable context similar to a smartphone or other mobile device.

By example, the Samsung Smart Gear watch is powered by a single-core 800 MHz processor, with accelerometer, multiple microphones and a camera. In this form factor new possibilities for always-on sensing are enabled. The device is always exposed to both the user's environment (as opposed to being in a pocket or purse) and in physical contact with the user.

Beyond having microphones and other sensors exposed, the placement on the body enables additional opportunities for activity recognition. In addition to acting as a simple pedometer, more advanced gait analysis can be performed providing additional insight in the user's subsequent search queries.

Unlike standalone training tools, such as a Garmin GPS watch or a Nike Fuel band, newer classes of wearable devices are always connected (via Bluetooth, WiFi, etc.). This means that the ability for a user's wearable device to provide information to a supply-side provider regarding training habits, gait analysis, even cardiovascular information can inform the user's subsequent search for a running shoe.

Other, less smart-phone like, architectures can also participate in the described architecture. Sensors that are not battery powered and can store sensor information, similar to a more advanced RFID chip, can also be used. Such sensors can take the form of jewelry, eye-ware, etc. Such sensors when activated in the presence of an electromagnetic field can report sensor results, such as number of activations (or power-ups) since the last time a download was occurred and the ID of those devices that were powering up the sensor.

The above can be thought of as a distributed sensing ecosystem, which can be created by using sensors in-place and shared by multiple users, in combination with battery-less, RFID enabled recorders for each user. Prototype, 3D printed rings have been proposed that carry all of a user's stored value or transit credentials, allowing the wearer to seamless move through turnstiles in many cities. If such a ring was also able to report on activations when queried, a snapshot of the day's commute would emerge. If sensors in the wearer's office building were made available, the ring could store average indoor air-quality during the work day. When queried at home, a picture of the wearer's environment could be created. Independent of the embodiment of the sensors and how sensor data is collected, the resulting information can be used in the same form described earlier and made available to the marketplace.

Body Sensors

On-body sensors are increasingly being paired with consumer smartphones for fitness and health. Beyond heart-rate monitoring for exercise, EKG, electro muscular signals, temperature and blood chemistry are being sensed in non-invasive fashions. Such sensors create new opportunities to collect and share context. Blood chemistry, respiratory health (microphones), heart-rate, all provide insight into what services or products the user may benefit from.

A long day of travel as sensed using a user's tie-clip or other jewelry, which has observed significant changes in GPS location, altitude, temperature, humidity, respiratory behavior, etc., can be a valuable source of context for specific brands. Emergen-C travel vitamins might be very interested in approaching travelers within 48 hours of completing an airplane trip, as may companies that sell products to the business traveler.

Review

A small sampling of some of the inventive arrangements detailed herein are reviewed in the following discussion.

One method includes sensing information about a user's physical—as opposed to computational—environment. The sensed information—or data derived from such information—is transmitted to a remote service for storage, in association with identifier data associated with the user (e.g., a cookie identifier). Then, in connection with a subsequent transaction, identifier data associated with the user allows access to the data about the user's earlier-sensed physical environment. This enables information presented to the user (e.g., a web page, digital signage, etc.), to be customized based on the information about the user's earlier physical environment.

Another method involves, at a first time, receiving information corresponding to audio or visual content sensed from a user's physical environment. Then, at a second, subsequent time, identifying advertising for presentation to the user, based at least in part on the identified information. The second time may follow the first time by a few seconds, but more typically follows it by several hours, or days or more.

A further aspect of the technology is a method in which a visual sensor of a first system acquires visual information representing first data. An audio sensor in a second system is then used to receive audio information representing the first data, where the received audio was emitted by the first system based on its acquisition of the visual information. The first data is extracted from the received audio, using a hardware processor configured to perform such act. Cookie data is then stored, based on the extracted first data.

Another such method involves a first system that includes a first sensor responsive to a first type of stimulus, which acquires information—representing first plural-bit data—conveyed by the first type of stimulus. A second system, using a second sensor responsive to a second type of stimulus different than the first type of stimulus, then receives information—again representing the first plural-bit data—conveyed by the second type of stimulus from the first system. The first plural-bit data represented by the information received by the second sensor is extracted, using a hardware processor configured to perform such act. Cookie data is then stored, based on the extracted first plural-bit data.

Another method includes, at a first time, receiving information about entertainment ambient content sensed by a microphone in a user's portable device, where the received information is accompanied by an identifier of the user, or the user's device. From this received information, a language apparently understood by the user is determined, and data related to this language is stored. Then, at a later time, a language-specific version of content to be provided to the user (or to the user's portable device) is selected, based on the stored data.

A related method involves, at a first time, receiving information about entertainment ambient content sensed by a microphone in a user's portable device, where the received information is accompanied by an identifier of the user, or the user's device. Based on the received information about ambient content, an age or education of the user is estimated, and related information is stored. At a later time, content to be provided to the user is selected, based on the stored data. (By such arrangement, the user's history of media consumption serves as a proxy for information about age or education.)

Yet another method includes sending a request for a web page from a user's device to a first web server. Responsive to this request, the device receives first information, including an ad tag URL. Data—including the ad tag URL (or a modified version of the ad tag URL)—is then sent to a second web server, responsive to which the user's device receives second information. A display is then presented to the user, based on the received first and second information. This method is characterized by sensing physical context data about the user or the user's environment, using a sensor in the user's device, and including information about the sensed physical context data with the data sent to the second web server.

Still another method involves discerning a set of item identifiers from items presented for purchase during a checkout operation by a shopper, using apparatus in a bricks and mortar store operated by a retailer. The set of item identifiers serves as a fingerprint by which that checkout operation can be distinguished from other checkout operations. Information related to the fingerprint is transmitted to a portable device conveyed by the shopper. The device relays this data—together with first information that serves as an identification of the shopper—to a computer system (which may be the store POS system, or another system). This fingerprint information is received, and matched with fingerprint information discerned by the apparatus. The first information, which serves as an identification of the shopper—is associated with the set of item identifiers discerned by the apparatus. This associates the purchased items with a particular shopper—information which is stored in a database. By such arrangement, purchased items are associated with a particular shopper, without the shopper directly providing shopper-identifying information to the retailer during the checkout operation. (The set of item identifiers can comprise an ordered set of such identifiers, to better avoid confusion with similar items purchased at other checkouts, albeit in different orders.)

A related method involves, from a point of sale terminal in a bricks and mortar store operated by a retailer, emitting a signal for detection by a shopper's portable device, each time an item presented for purchase in a checkout operation is sensed. These emitted signals define a temporal sequence that serves as a fingerprint by which that checkout operation can be identified, and distinguished from other checkout operations. The shopper's device receives these signals, and sends data including first sequence information based on its detection of the emitted signals, and also including first information that serves as an identification of the shopper. This data sent by the shopper's device is received, and matched with corresponding second sequence information generated as part of the checkout operation. The first information—that serves as an indication of the shopper—is then associated with the second sequence information, to thereby associate the first information with a particular checkout operation. By such arrangement, the first information—which serves as an identification of the shopper—is associated with a particular checkout operation, without the shopper directly providing shopper-identifying information to the retailer during the checkout operation.

A further aspect of the technology comprises compiling, in a data structure, two or more types of information from the group consisting of: (a) a user's online activities, including web sites visited; (b) entertainment content sensed by a microphone-equipped device conveyed by the user; and (c) a record of items purchased by the user in a bricks and mortar store. Advertising is then selected for presentation to the user, based on these two or more types of information.

Yet a further method includes, at a first time, receiving sensor information from an apparatus worn on a wrist of a user. Data related to this received sensor information is stored in a data structure remote from the user, in association with cookie data that serves as an identifier of the user. Then, at a second time, the stored data is accessed by reference to the cookie data, and used in identifying information to present to the user.

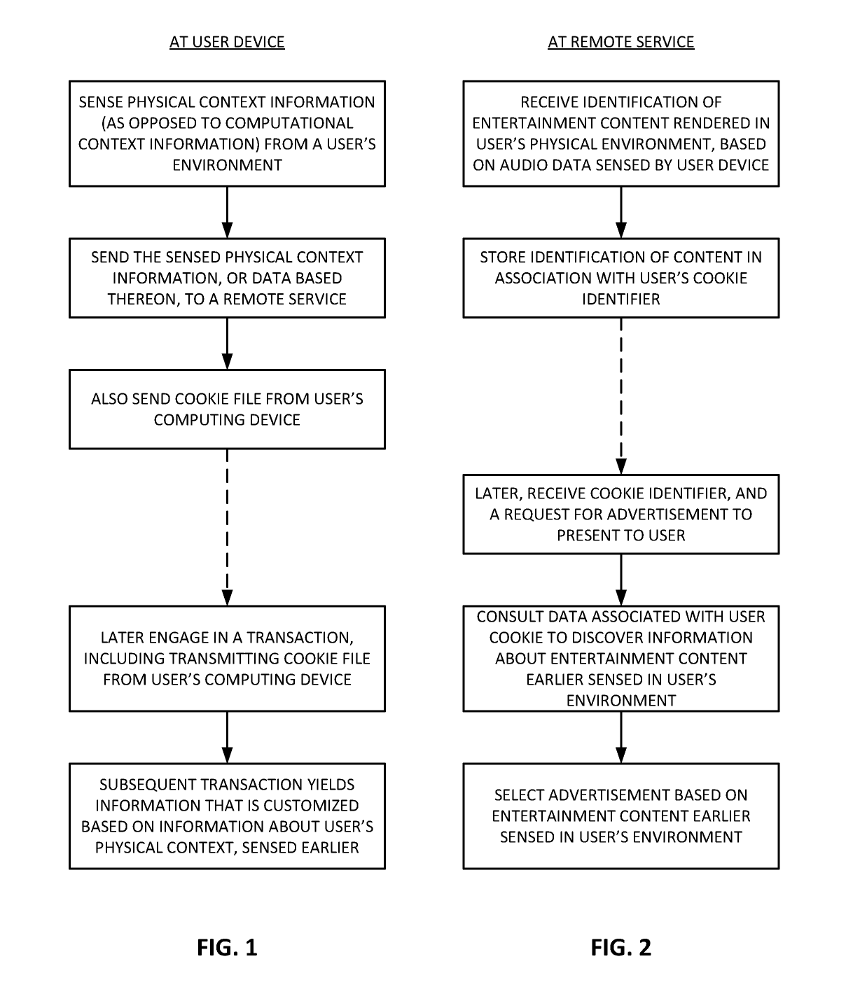

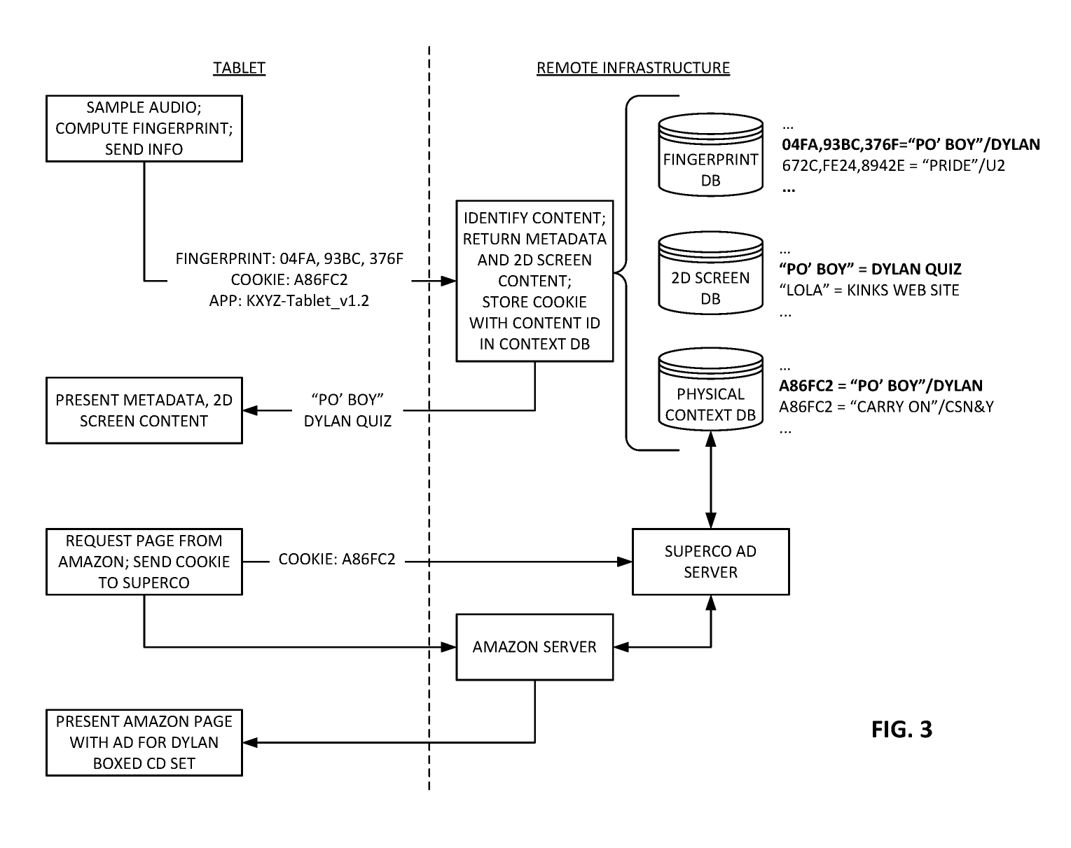

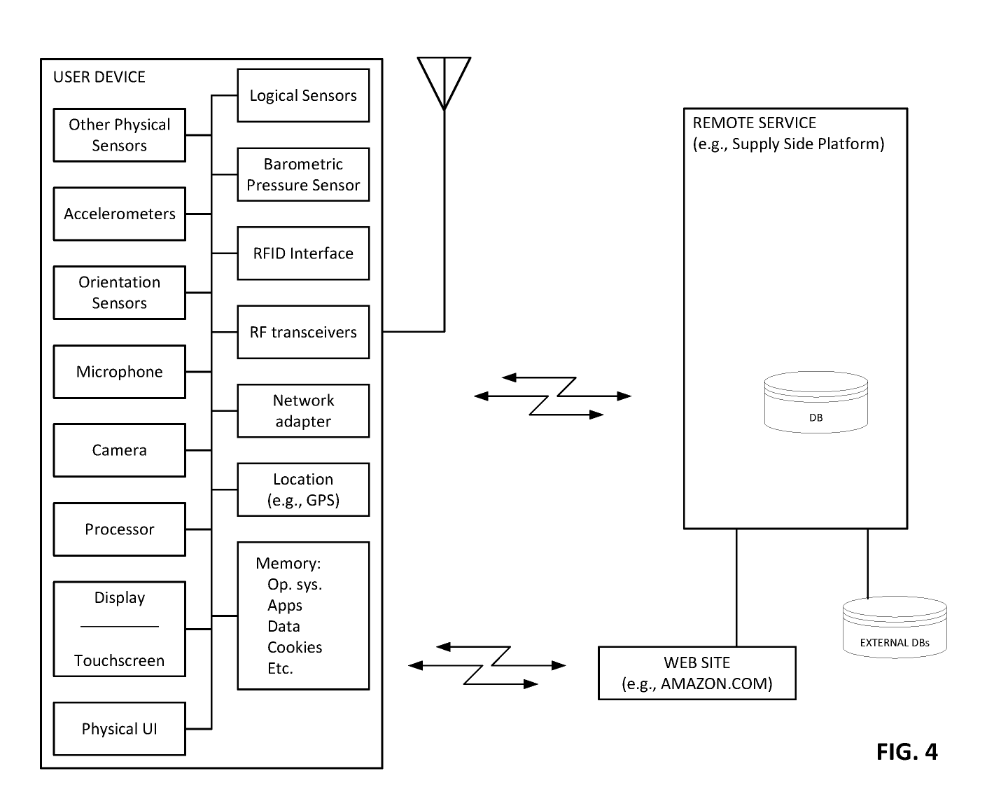

FIGS. 1-4 illustrate aspects of the foregoing arrangements.

### Concluding Remarks

Having described and illustrated the principles of our technology by reference to certain embodiments, it will be apparent that the technology is not so limited.

For example, while reference was made to sampling audio output from a radio or television, in other embodiments video can be sampled, e.g., using the camera of a cell phone. Watermarks and fingerprints can be derived from the captured image/video data, and used as detailed above.

Similarly, processing other than watermark- and fingerprint-based content identification can be used. One such alternative is speech recognition. Another is speaker recognition. Still another is audio classification. A system may thereby discern, e.g., that the user is in a crowded public place—such as a busy shopping venue—based on the sampled audio (e.g., a jumble of speech-like phonemes that can't be recognized), and systems interacting with the user/user device can tailor their behavior accordingly. (Again, combined use of media content information with location information allows still more accurate context classification.)

Moreover, while certain of the implementations contemplate outputting a web page to the user on a tablet (or other) display screen, other types of information (including non-visual) can be presented, using other devices.

One particular example is augmented reality glasses. Such devices can overlay logos and other computer-generated indicia over a real-world scene presented to the user. Different augmentations can be presented to different users, based on their respective historical- and currently-sensed context information.

Consider a baseball stadium, with advertising display screens arrayed in a border ringing the field. These screens present corporate logos and other familiar forms of advertising to the general public. Users with augmented reality glasses, however, find that their glasses overlay, in those locations, content that is better tailored to their interests—again by reference to personal historical and real-time context data indicated by a user-identifying cookie. Again, an auction model can be employed, whereby different people see different presentations in this viewing real estate, based on what their cookies respectively reveal.

While the disclosure has focused on presentation of visual information tailored to the user, the same principles can likewise be used to tailor auditory information presented to the user.

As noted earlier, the sensing of physical context information can occur at one time, and its use can occur at a second time, where the second time is the same as the first time, or follows the first time by 5, 10, 30, 60, or 300 or more, seconds or minutes.

Ad serving companies typically have maintained the backend databases that aggregate context information about a user's digital browsing history. However, different companies may emerge to aggregate the other types of context information detailed herein.

While one of the detailed arrangements contemplates the user device sending cookie data twice—once in connection with transmitting data about the physical environment (e.g., audio), and once in connection with a subsequent transaction (e.g., requesting a web page), this is not necessary. In alternative embodiments cookie data needn't be sent to identify the user. For example, a remote system can identify the user (or the user device) otherwise, such as by an IP address included in the packet stream that conveys the data about the user's physical environment, or that conveys a request for a web page. The IP address can be associated with the user (and/or the user's cookie data) using a table, database, or other data structure. In some implementations, cookie data isn't used at all. The user's identity is conveyed or discerned otherwise in each transaction between the user device and the remote system.

While the remote system is sometimes referenced as a unitary entity (as in the preceding sentence), it is more often a distributed system—involving multiple computer servers at multiple locations, operated by multiple different parties. (The appendix begins to illustrate the many different parties that may be involved.)

In one of the earlier examples, a watermark detector forms part of a tablet app distributed by radio station KXYZ-FM. In other embodiments, software code for a watermark detector (or a fingerprint engine) may form part of a Java Native Interface (JNI) library downloaded to a user's device with a web page. Thereafter, when that web page, or another, wants information about the user's context, it can invoke the earlier-stored code with JNI. The Java instructs the device to activate its microphone and associated software modules, decode any watermark, and write cookies (or call out to another service that writes cookies) accordingly.

While the emphasis of the disclosure has been on environmental context, sensed by device sensors, it will be recognized that the present technology is useful with all other forms of context.

Context is sometimes defined as any information useful in characterizing the situation of an entity. An entity is a person, place or object that is considered relevant to an interaction with a user.

Such context information can be of many sorts, including computing context (network connectivity, memory availability, processor type, CPU contention, etc.), user context (user profile, location, actions, preferences, nearby friends, social network(s) and situation, etc.), physical context (e.g., lighting, noise level, traffic, etc.), temporal context (time of day, day, month, season, etc.), history of the above, etc.

Although disclosed as complete systems, subcombinations of the detailed arrangements are also separately contemplated.

While consumers have been trained to think of automated content recognition (such as by the Shazam app), as being performed occasionally—when identification of a particular content object is requested by a user, the inventors expect that such recognition will eventually become ubiquitous and continuous. Physical sensors will be free-running, and sensed data (and its derivatives—such as recognized content information) will be always available (hopefully with some automated destruction after a suitable period of time.) The present technology works in both scenarios—with physical context being sensed in response to a user action, or being sensed continuously. The latter provides a richer set of context data by which system responses to the user can more accurately be customized.

While certain of the detailed embodiments focused on audio sampled from a television or radio, it will be recognized that these are illustrative only and not limiting. For example, such audio may be sampled in a movie theatre, in a nightclub, etc.

While the present technology has been described mainly in the context of third-party, cookie-based arrangements, it is applicable in other systems as well. For example, Microsoft, Facebook, Google, and Apple, are each promoting their respective technologies for identifying consumers on the web—without use of third-party cookies. For example, one Microsoft system employs device-specific identifiers, which are associated together in a cloud database as used by one particular individual. Facebook's technology relies on its unique user logins. Google's system (AdID) and Apple's system (Identifier for Advertising, or ADFA) similarly aim to supplant third-party cookies with identification technologies that they themselves govern—allowing more granular usage and privacy controls.

Related technologies by these companies are detailed in patent documents 20090119167, 20110167079, 20110307323, 20110321167, 20120116875, 20120316956, U.S. Pat. Nos. 8,060,402, 8,082,179, and 8,484,073. Applicant's invention encompasses the technology described herein, as applied to such alternatives to third-party cookies.

In addition to the above-noted alternatives to classic (HTTP) cookies, other means of identifying an online user (and device) include IP address (noted above), URL (query string), hidden form fields, HTTP authentication data (based on user name and password, etc.), and the DOM (Document Object Model) property “window.name,” which are familiar to artisans in the field (and are detailed, e.g., in the Wikipedia article for HTTP Cookie dated Dec. 4, 2013). Unless used with the adjective “HTTP,” the term “cookie” herein should be construed to encompass such alternative forms of user or device identification.

While reference has been made to smartphones, it will be recognized that this technology finds utility with all manner of devices—both portable and fixed. Tablets, laptop computers, digital cameras, wrist- and head-mounted systems and other wearable devices, servers, etc., can all make use of the principles detailed herein. (The term “smartphone” should be construed herein to encompass all such devices, even those that are not telephones.)

Sample smartphones include the Apple iPhone 5; smartphones following Google's Android specification (e.g., the Galaxy S4 phone, manufactured by Samsung, and the Google Moto X phone, made by Motorola), and Windows 8 mobile phones (e.g., the Nokia Lumia 1020, which features a 41 megapixel camera).

Details of the Apple iPhone, including its touch interface, are provided in Apple's published patent application 20080174570.

The design of smartphones, tablets, and other devices/computers referenced in this disclosure is familiar to the artisan. In general terms, each includes one or more processors, one or more memories (e.g. RAM), storage (e.g., a disk or flash memory), a user interface (which may include, e.g., a keypad, a TFT LCD or OLED display screen, touch or other gesture sensors, a camera or other optical sensor, a microphone, etc., together with software instructions for providing a graphical user interface), and an interface for communicating with other devices (which may be wireless, as noted above, and/or wired, such as through an Ethernet local area network, a T-1 internet connection, etc.).

The processes and system components detailed in this specification may be implemented as instructions for computing devices, including general purpose processor instructions for a variety of programmable processors, including microprocessors (e.g., the Intel Atom, the ARM A5, the Qualcomm Snapdragon, and the NVidia Tegra 4; the latter includes a CPU, a GPU, and NVidia's Chimera computational photography architecture), graphics processing units (GPUs, such as the NVidia Tegra APX 2600, and the Adreno 330—part of the Qualcomm Snapdragon processor), and digital signal processors (e.g., the Texas Instruments TMS320 and OMAP series devices), etc. These instructions may be implemented as software, firmware, etc. These instructions can also be implemented in various forms of processor circuitry, including programmable logic devices, field programmable gate arrays (e.g., the Xilinx Virtex series devices), field programmable object arrays, and application specific circuits—including digital, analog and mixed analog/digital circuitry. Execution of the instructions can be distributed among processors and/or made parallel across processors within a device or across a network of devices. Processing of data may also be distributed among different processor and memory devices. As noted, cloud computing resources can be used as well. References to “processors,” “modules” or “components” should be understood to refer to functionality, rather than requiring a particular form of implementation.

Software instructions for implementing the detailed functionality can be authored by artisans without undue experimentation from the descriptions provided herein, e.g., written in C, C++, Visual Basic, Java, Python, Tcl, Perl, Scheme, Ruby, etc., in conjunction with associated data. Smartphones and other devices according to certain implementations of the present technology can include software modules for performing the different functions and acts.

Known browser software, communications software, imaging software, and media processing software can be adapted for use in implementing the present technology.

Software and hardware configuration data/instructions are commonly stored as instructions in one or more data structures conveyed by non-transitory tangible media, such as magnetic or optical discs, memory cards, ROM, etc., which may be accessed across a network. Some embodiments may be implemented as embedded systems—special purpose computer systems in which operating system software and application software are indistinguishable to the user (e.g., as is commonly the case in basic cell phones). The functionality detailed in this specification can be implemented in operating system software, application software and/or as embedded system software.

Different of the functionality can be implemented on different devices. For example, in a system in which a smartphone communicates with a computer at a remote location, different tasks can be performed exclusively by one device or the other, or execution can be distributed between the devices. Extraction of fingerprint and watermark data from content is one example of a process that can be distributed in such fashion. Thus, it should be understood that description of an operation as being performed by a particular device (e.g., a smartphone) is not limiting but exemplary; performance of the operation by another device (e.g., a remote server), or shared between devices, is also expressly contemplated.

In like fashion, description of data being stored on a particular device is also exemplary; data can be stored anywhere: local device, remote device, in the cloud, distributed, etc.

As indicated, the present technology can be used in connection with wearable computing systems, including headworn devices. Such devices typically include display technology by which computer information can be viewed by the user—either overlaid on the scene in front of the user (sometimes termed augmented reality), or blocking that scene (sometimes termed virtual reality), or simply in the user's peripheral vision. Exemplary technology is detailed in patent documents U.S. Pat. No. 7,397,607, 20100045869, 20090322671, 20090244097 and 20050195128. Commercial offerings, in addition to the Google Glass product, include the Vuzix Smart Glasses M100, Wrap 1200AR, and Star 1200XL systems. An upcoming alternative is augmented reality contact lenses. Such technology is detailed, e.g., in patent document 20090189830 and in Parviz, Augmented Reality in a Contact Lens, IEEE Spectrum, September, 2009. Some or all such devices may communicate, e.g., wirelessly, with other computing devices (carried by the user or otherwise), or they can include self-contained processing capability. Likewise, they may incorporate other features known from existing smart phones and patent documents, including electronic compass, accelerometers, gyroscopes, camera(s), projector(s), GPS, etc.

As noted, watermark technology can be used in various embodiments. Technology for encoding/decoding watermarks is detailed, e.g., in Digimarc's patents U.S. Pat. Nos. 6,614,914, 6,590,996 and 6,122,403; in Nielsen's patents U.S. Pat. Nos. 6,968,564 and 7,006,555; and in Arbitron's patents U.S. Pat. Nos. 5,450,490, 5,764,763, 6,862,355, and 6,845,360.

Content fingerprinting can also be used in various embodiments. Examples of audio fingerprinting are detailed in patent publications 20070250716, 20070174059 and 20080300011 (Digimarc), 20080276265, 20070274537 and 20050232411 (Nielsen), 20070124756 (Google), U.S. Pat. Nos. 7,516,074 (Auditude), and 6,990,453 and 7,359,889 (both Shazam). Examples of image/video fingerprinting are detailed in patent publications U.S. Pat. Nos. 7,020,304 (Digimarc), 7,486,827 (Seiko-Epson), 20070253594 (Vobile), 20080317278 (Thomson), and 20020044659 (NEC).

Other fingerprint-based content identification techniques are well known. SIFT, SURF, ORB and CONGAS are some of the most popular algorithms. (SIFT, SURF and ORB are each implemented in the popular OpenCV software library, e.g., version 2.3.1. CONGAS is used by Google Goggles for that product's image recognition service, and is detailed, e.g., in Neven et al, “Image Recognition with an Adiabatic Quantum Computer I. Mapping to Quadratic Unconstrained Binary Optimization,” Arxiv preprint arXiv:0804.4457, 2008.)

Still other fingerprinting techniques are detailed in patent publications 20090282025, 20060104598, WO2012004626 and WO2012156774 (all by LTU Technologies of France).

Yet other fingerprinting techniques are variously known as Bag of Features, or Bag of Words, methods. Such methods extract local features from patches of an image (e.g., SIFT points), and automatically cluster the features into N groups (e.g., 168 groups)—each corresponding to a prototypical local feature. A vector of occurrence counts of each of the groups (i.e., a histogram) is then determined, and serves as a reference signature for the image. To determine if a query image matches the reference image, local features are again extracted from patches of the image, and assigned to one of the earlier-defined N-groups (e.g., based on a distance measure from the corresponding prototypical local features). A vector occurrence count is again made, and checked for correlation with the reference signature. Further information is detailed, e.g., in Nowak, et al, Sampling strategies for bag-of-features image classification, Computer Vision—ECCV 2006, Springer Berlin Heidelberg, pp. 490-503; and Fei-Fei et al, A Bayesian Hierarchical Model for Learning Natural Scene Categories, IEEE Conference on Computer Vision and Pattern Recognition, 2005; and references cited in such papers.

Digimarc has various other patent filings relevant to the present subject matter. See, e.g., patent publications U.S. Pat. Nos. 8,498,627, 8,412,577, 6,947,571, 20130150117, 20120284012, 20100046842, 20070156726, 20080049971, and 20070266252, and pending applications Ser. No. 12/125,840, filed May 22, 2008 (now U.S. Pat. No. 9,466,307); Ser. No. 13/946,968, filed Jul. 19, 2013 (now U.S. Pat. No. 9,129,277); Ser. No. 14/074,072, filed Nov. 7, 2013 (published as 20140258110); 61/838,165, filed Jun. 21, 2013; and 61/818,839, filed May 2, 2013.

Additional information about ad serving is provided in a series of articles published by adopsinsider<dot>com, attached as an appendix.

This specification has discussed several different embodiments. It should be understood that the methods, elements and concepts detailed in connection with one embodiment can be combined with the methods, elements and concepts detailed in connection with other embodiments. While some such arrangements have been particularly described, many have not—due to the large number of permutations and combinations. Applicant similarly recognizes and intends that the methods, elements and concepts of this specification can be combined, substituted and interchanged—not just among and between themselves, but also with those known from the cited art. Moreover, it will be recognized that the detailed technology can be included with other technologies—current and upcoming—to advantageous effect. Implementation of such combinations is straightforward to the artisan from the teachings provided in this disclosure.

While this disclosure has detailed particular ordering of acts and particular combinations of elements, it will be recognized that other contemplated methods may re-order acts (possibly omitting some and adding others), and other contemplated combinations may omit some elements and add others, etc.

Although disclosed as complete systems, sub-combinations of the detailed arrangements are also separately contemplated (e.g., omitting various of the features of a complete system).

While certain aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

The present specification should be read in the context of the cited references. (The reader is presumed to be familiar with such prior work.) Those references disclose technologies and teachings that the inventors intend be incorporated into embodiments of the present technology, and into which the technologies and teachings detailed herein be incorporated.

To provide a comprehensive disclosure, while complying with the statutory requirement of conciseness, applicant incorporates-by-reference each of the documents referenced herein. (Such materials are incorporated in their entireties, even if cited above in connection with specific of their teachings.) These references disclose technologies and teachings that can be incorporated into the arrangements detailed herein, and into which the technologies and teachings detailed herein can be incorporated. The reader is presumed to be familiar with such prior work.

In view of the wide variety of embodiments to which the principles and features discussed above can be applied, it should be apparent that the detailed embodiments are illustrative only, and should not be taken as limiting the scope of the invention. Rather, we claim as our invention all such modifications as may come within the scope and spirit of the following claims and equivalents thereof.

1. An audio processing method practiced by a user's computing apparatus, comprising the acts:
sensing audio from an ambient environment of the user with a microphone of said apparatus;
(b) processing the sensed audio to produce processed data, said processing comprising deriving audio fingerprint data, or decoding digital watermark data, from the sensed audio;
(c) transmitting the processed data from the user's computing apparatus to a remote service, and also transmitting identifier data associated with the user; and
(d) a day or more after act (c), and in connection with a subsequent transaction, again transmitting said identifier data associated with the user from the user's computing apparatus—this time to a remote system different than said remote service, and as a following part of said subsequent transaction, receiving audio, image and/or video content information, and rendering said audio, image and/or video content information to the user with the user's computing apparatus;
wherein the audio, image and/or video content information rendered to the user is customized based on the audio sensed from the user's ambient environment in act (a), a day or more earlier.

2-54. (canceled)

55. The method of claim 58 that further includes:
performing, with said user's computing apparatus, further environmental sensing including one or more of: (i) voice-based speaker identification, (ii) barometric pressure sensing, (iii) heart rate sensing, and (iv) olfactory sensing; and
transmitting resulting environmental sensing data to the remote service;
wherein as part of the subsequent transaction, the rendered audio, image and/or video content information is also customized based on said further environmental sensing data.

56. The method of claim 1 wherein said processing includes performing a hashing operation on the sensed audio.

57. The method of claim 1 in which the transmitting of act (d) is performed in response to a request from a web site with which the user's computing apparatus is in communication.

58. The method of claim 1 in which the sensing comprises sensing with a microphone worn on the user's wrist, finger or face.

59. The method of claim 1 that includes discerning a social relationship between the user and another individual based, in part, on said transmitted processed data, wherein the audio, image and/or video content information rendered to the user is also customized based on said discerned social relationship.

60. The method of claim 1 wherein the identifier data associated with the user comprises cookie data associated with the user, and corresponds to a cookie file stored in storage of the user's computing apparatus; and the method includes, in connection with the subsequent transaction, transmitting the stored cookie file from the user's computing apparatus.

61. The method of claim 1 that includes discerning a demographic classification for the user, based on the sensed audio, and customizing the information for rendering based on said discerned demographic classification.

62. A method practiced by a computer system remote from a user device, comprising the acts:
(a) receiving processed ambient audio data sent from the user device, corresponding to audio sensed from an ambient environment of the user;
(b) storing the processed ambient audio data in association with identifier information for the user;
(c) a day or more after act (b), and in connection with a subsequent transaction that requests delivery of content information comprising audio, image and/or video to the user device, again receiving identifier information for the user; and
(d) tailoring the requested audio, image and/or video content information sent to the user device based on the stored processed data;
wherein the audio, image and/or video content sent to the user device is customized based on the audio sensed from the user's ambient environment in act (a), a day or more earlier.

63. The method of claim 62 that includes discerning a demographic classification for the user, based on the received processed ambient audio data, and tailoring the audio, image and/or video content information sent to the user device based on said discerned demographic classification.

64. The method of claim 62 that includes discerning a language preference for the user, based on the received processed ambient audio data, and tailoring the audio, image and/or video content information sent to the user device based on said discerned language preference.

65. The method of claim 62 that includes discerning age information for the user, based on the received processed ambient audio data, and tailoring the audio, image and/or video content information sent to the user device based on said discerned age information.

66. The method of claim 62 that includes discerning education information for the user, based on the received ambient audio data, and tailoring the audio, image and/or video content information sent to the user device based on said discerned education classification.

67. A content processing method comprising the acts:
at a computer system, receiving a request sent by a user device “A” and a request sent by a user device “B,” both requests identifying the same content information for requested delivery, the identified content information comprising audio, image and/or video content information;
in response to said received requests, the computer system sending user device “A” a first set of content and sending user device “B” a second, different set of content;
wherein although requests received from devices “A” and “B” both identify the same particular content information for requested delivery, the method includes the computer system customizing the second set of content, sent to user device “B,” due to audio information sensed in an ambient environment of device “B” more than an hour before the content request was received by the computer system from device “B.”

68. The method of claim 67 that further includes: more than an hour before the request from device “B” was received, receiving cookie information from device “B,” the cookie information including an identifier, together with watermark or fingerprint data corresponding to ambient audio sensed by a microphone in device “B” from an environment of said device “B;” said identifier being received again accompanying said request for content information sent by user device “B.”
